(19) United States
(12) Patent Application Publication
(10) Pub. No.: US 2017/0014863 A1
(43) Pub. Date: Jan. 19, 2017

(54) WEB COATING APPARATUS AND WEB COATING METHOD

(71) Applicant: JTEKT CORPORATION, Osaka-shi (JP)

(72) Inventors: Takumi MIO, Kariya-shi (JP); Koji NISHI, Anjo-shi (JP); Yoshiki MARUYAMA, Okazaki-shi (JP)

(73) Assignee: JTEKT CORPORATION, Osaka-shi (JP)

(21) Appl. No.: 15/209,144

(22) Filed: Jul. 13, 2016

(30) Foreign Application Priority Data
Jul. 17, 2015 (JP) 2015-142626

(51) Int. Cl. B05D 3/12; B05C 1/08

(52) U.S. Cl. CPC B05D 3/12; B05C 1/08

(57) ABSTRACT

A web coating apparatus applies a coating material to surfaces of a web being transferred. The web coating apparatus includes: a cutting apparatus that makes cuts in the web being transferred so that the cuts extend through the web; an extending apparatus that extends the web in the lateral direction of the web and widens the cuts in the lateral direction of the web; and coating material discharging apparatuses that apply the coating material to the surfaces of the web extended in the lateral direction of the web.

### INCORPORATION BY REFERENCE

The disclosure of Japanese Patent Application No. 2015-142626 filed on Jul. 17, 2015 including the specification, drawings and abstract, is incorporated herein by reference in its entirety.

### BACKGROUND OF THE INVENTION

1. Field of the Invention

The present invention relates to web coating apparatuses and web coating methods.

2. Description of the Related Art

Lithium ion capacitors are structured by combination of a negative electrode of a lithium ion secondary battery and a positive electrode of an electric double layer capacitor. Positive and negative electrodes of the lithium ion capacitors are produced by applying an electrode material (coating material) to surfaces of electrode foil (web) by using a web coating apparatus.

The lithium ion capacitors are produced by alternately stacking positive and negative electrodes with a separator interposed therebetween, placing metal foil containing metal lithium on the stack, and doping the negative electrodes with lithium ions. The negative electrode potential of the lithium ion capacitors can be reduced by predoping, namely by doping the negative electrodes with lithium ions. The lithium ion capacitors thus have a higher cell voltage than electric double layer capacitors.

However, the metal foil containing metal lithium is placed so as to adjoin one surface of the stack in the direction in which the positive and negative electrodes are stacked. Accordingly, the negative electrode located on the other surface of the stack in the direction in which the positive and negative electrodes are stacked may not be sufficiently doped with lithium ions. As a solution to this problem, for example, Japanese Patent Application Publication Nos. 2011-165930 (JP 2011-165930 A) and 2010-135361 (JP 2010-135361 A) disclose lithium ion capacitors having a multiplicity of holes in a web. In such lithium ion capacitors, lithium ions pass through the holes and can thus easily reach the negative electrode located on the other surface of the stack in the direction in which the positive and negative electrodes are stacked.

In the lithium ion capacitor described in JP 2011-165930 A, a coating apparatus applies a coating material to the surfaces of a web, and then a transfer roller having a plurality of projections forms holes in the web while transferring the web. Accordingly, the transfer roller may be contaminated by the coating material, and a plurality of kinds of transfer rollers are required in order to vary the area ratio of the holes per unit area of the web, namely the opening ratio of the web.

In the lithium ion capacitor described in JP 2010-135361 A, a transfer roller having a plurality of cutting edges forms slits in a web while transferring the web, a coating apparatus then applies a coating material to a surface of the web, and a press roller presses the web to increase the widths of the slits to form holes. In this configuration, the transfer roller located upstream of the coating apparatus is not contaminated by the coating material, and the opening ratio of the web can be adjusted.

However, since the coating material hardly remains in the widened holes, the ratio of the volume of the coating material to the overall volume of the lithium ion capacitor, namely the volumetric energy density, may be reduced. Moreover, since the web has a multiplicity of holes, the strength of the web may be reduced and the web may be torn while being transferred.

### SUMMARY OF THE INVENTION

It is one object of the present invention to provide a web coating apparatus and a web coating method which allow a coating material to remain in holes formed in a web.

A web coating apparatus according to one aspect of the present invention is a web coating apparatus that applies a coating material to a surface of a web being transferred.

This web coating apparatus includes: a cutting apparatus that makes cuts in the web being transferred so that the cuts extend through the web; an extending apparatus that extends the web in a lateral direction of the web and widens the cuts in the lateral direction of the web; and a coating material discharging apparatus that applies the coating material to the surface of the web extended in the lateral direction of the web.

In the web coating apparatus of the above aspect, the coating material is applied to the web after the cuts are widened to form the holes. This allows the coating material to remain in the holes. Since the holes are filled with the coating material, reduction in strength of the web can be prevented. Since the cuts are widened to form the holes by extending the web in the lateral direction of the web, the area ratio of the holes per unit area of the web, namely the opening ratio of the web, can be varied. Since the cuts are widened to form the holes before the coating material is applied to the web, members located upstream of the coating material discharging apparatus are not contaminated by the coating material.

A web coating method according to another aspect of the present invention is a web coating method for applying a coating material to a surface of a web being transferred.

This web coating method includes: making cuts in the web being transferred so that the cuts extend through the web; extending the web in a lateral direction of the web and widening the cuts in the lateral direction of the web; and applying the coating material to the surface of the web extended in the lateral direction of the web.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram showing the general configuration of a web coating apparatus;

FIG. 2A is a diagram showing a cutting roller of a cutting apparatus as viewed in a direction perpendicular to a roller shaft of the cutting roller;

FIG. 2B is a diagram showing the cutting roller of the cutting apparatus as viewed in the axial direction of the cutting roller;

FIG. 3A is a diagram showing holding rollers of an extending apparatus as viewed in a direction perpendicular to roller shafts of the holding rollers;

FIG. 3B is a diagram showing the holding rollers of the extending apparatus as viewed in the axial direction of the holding rollers;

FIG. 4 is a flowchart illustrating operation of the web coating apparatus;

FIG. 5 is a diagram illustrating a cutting operation of the cutting roller of the cutting apparatus;

FIG. 6 is a diagram illustrating an extending operation of the holding rollers of the extending apparatus;

FIG. 7 is a diagram showing a cutting roller in another example of the cutting apparatus as viewed in a direction perpendicular to a roller shaft of the cutting roller; and

FIG. 8 is a diagram showing another example of cuts that are made by the cutting apparatus and showing how the cuts are gradually widened.

### DETAILED DESCRIPTION OF EMBODIMENTS

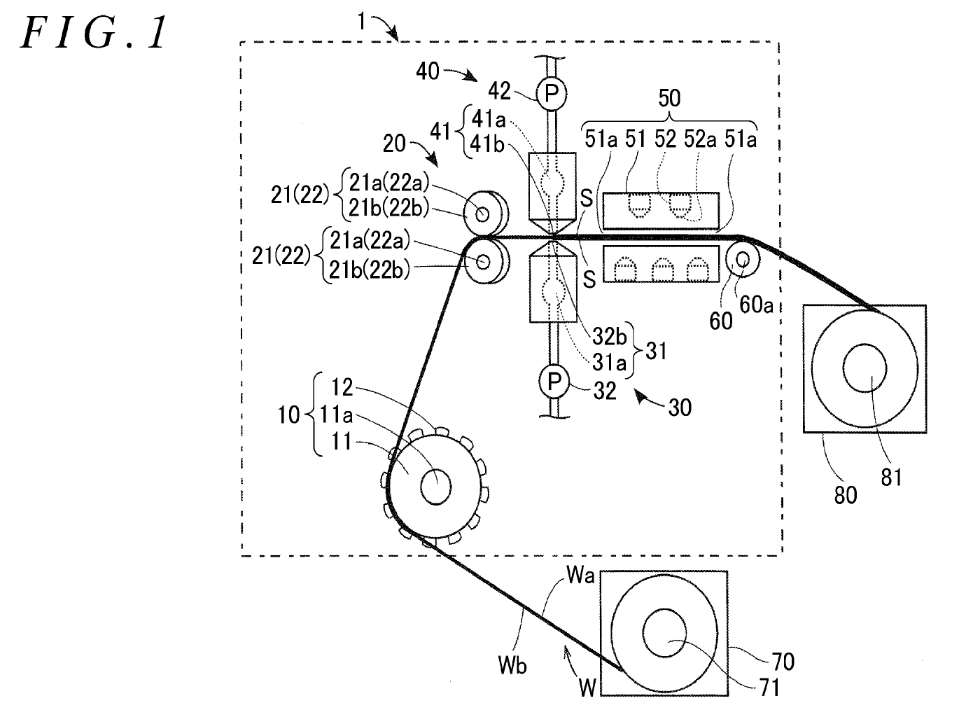

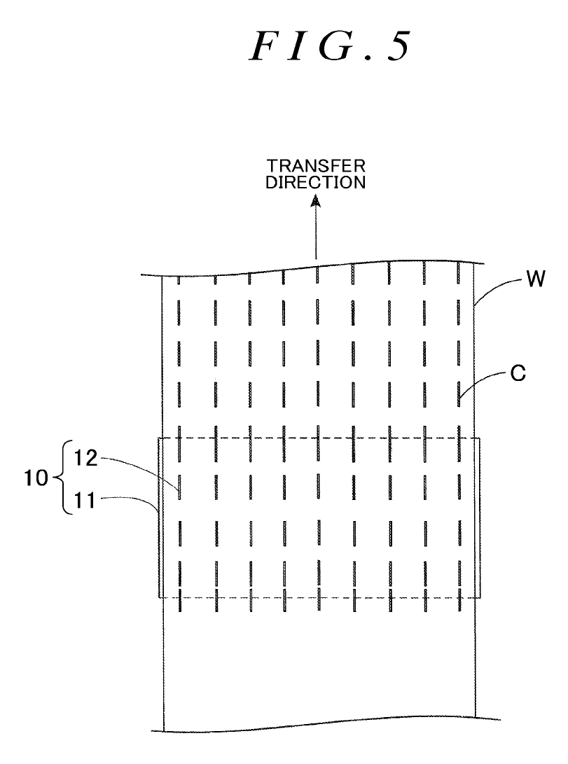

The general configuration of an embodiment of a web coating apparatus of the present invention will be described with reference to FIG. 1. As shown in FIG. 1, a web coating apparatus 1 of the present embodiment includes a cutting apparatus 10 and an extending apparatus 20. The cutting apparatus 10 makes cuts C (see FIG. 5) in a web W being transferred so that the cuts C extend through the web W. The extending apparatus 20 extends the web W in the lateral direction of the web W and widens the cuts C in the lateral direction of the web W.

The web coating apparatus 1 further includes a first coating material discharging apparatus 30, a second coating material discharging apparatus 40, a drying apparatus 50, etc. The first coating material discharging apparatus 30 discharges a coating material S to one surface Wa of the web W while transferring the web W. The second coating material discharging apparatus 40 discharges the coating material S to the other surface Wb of the web W while transferring the web W. The drying apparatus 50 dries the coating material S applied to both surfaces Wa, Wb of the web W.

The web coating apparatus 1 is placed between an unwinding apparatus 70 that unwinds the web W and a winding apparatus 80 that winds up the web W such that the cutting apparatus 10, the extending apparatus 20, the first and second coating material discharging apparatuses 30, 40, the drying apparatus 50, and a transfer roller 60 are arranged in this order from the upstream side to the downstream side of a path along which the web W is transferred.

A rotary shaft 71 of the unwinding apparatus 70 and a rotary shaft 81 of the winding apparatus 80 are arranged parallel and next to each other. The web W wound up into a roll is set in the unwinding apparatus 70. The roll of the web W is unwound from the unwinding apparatus 70. The unwound web W passes through the apparatuses 10, 20, 30, 40, 50 in order in which these apparatuses 10, 20, 30, 40, 50 are arranged as described above, passes through the transfer roller 60, and is wound up by the winding apparatus 80.

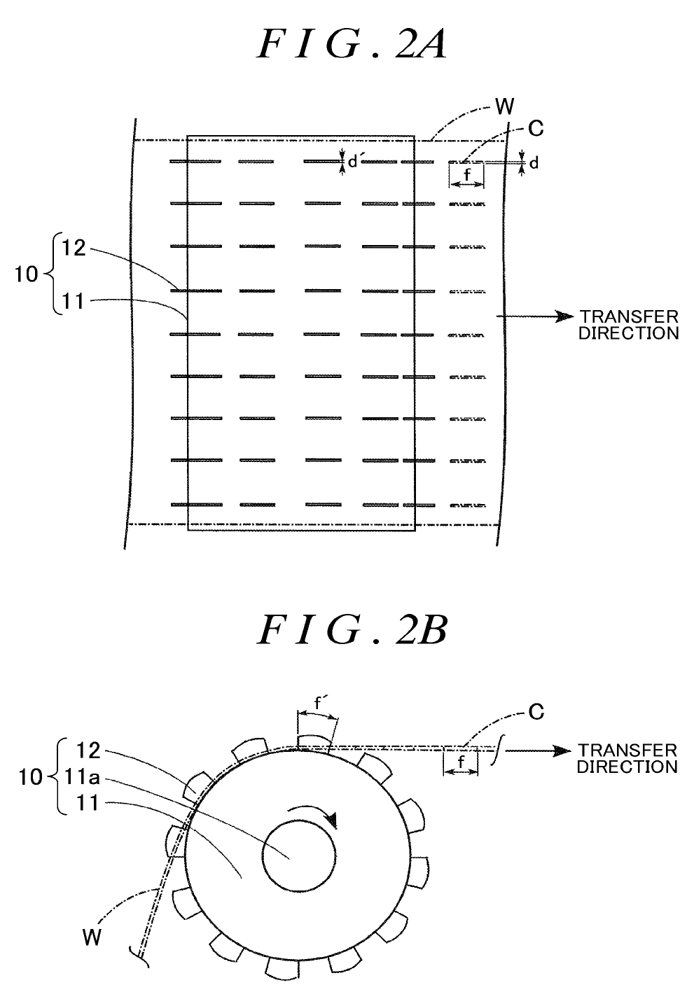

As shown in FIGS. 1, 2A, and 2B, the cutting apparatus 10 includes a cutting roller 11. The cutting roller 11 has a plurality of cutting edges 12 projecting from its peripheral surface, and can rotate about a roller shaft 11a as the web W is transferred. The cutting roller 11 is disposed next to the unwinding apparatus 70. Specifically, the cutting roller 11 is disposed obliquely above the unwinding apparatus 70 so as to be separated by a predetermined distance from the unwinding apparatus 70 and such that the roller shaft 11 a extends parallel to the rotary shaft 71 of the unwinding apparatus 70.

The cutting roller 11 has the cutting edges 12 projecting from its peripheral surface so that a plurality of (in this example, nine) cutting edges 12 are arranged at regular distance intervals in the axial direction and a plurality of (in this example, twelve) cutting edges are arranged at regular angular intervals in the circumferential direction. The cutting edges 12 can make cuts in the web W linearly in the direction in which the web W is transferred, while the web W is being transferred. Each of the cuts C formed by the cutting edges 12 is larger in length f in the direction in which the web W is transferred than in length d in the lateral direction of the web W. Each cutting edge 12 has an outer peripheral length f′ in the direction in which the web W is transferred and a length d′ in the axial direction of the web W so that it can form the cuts C (f×d).

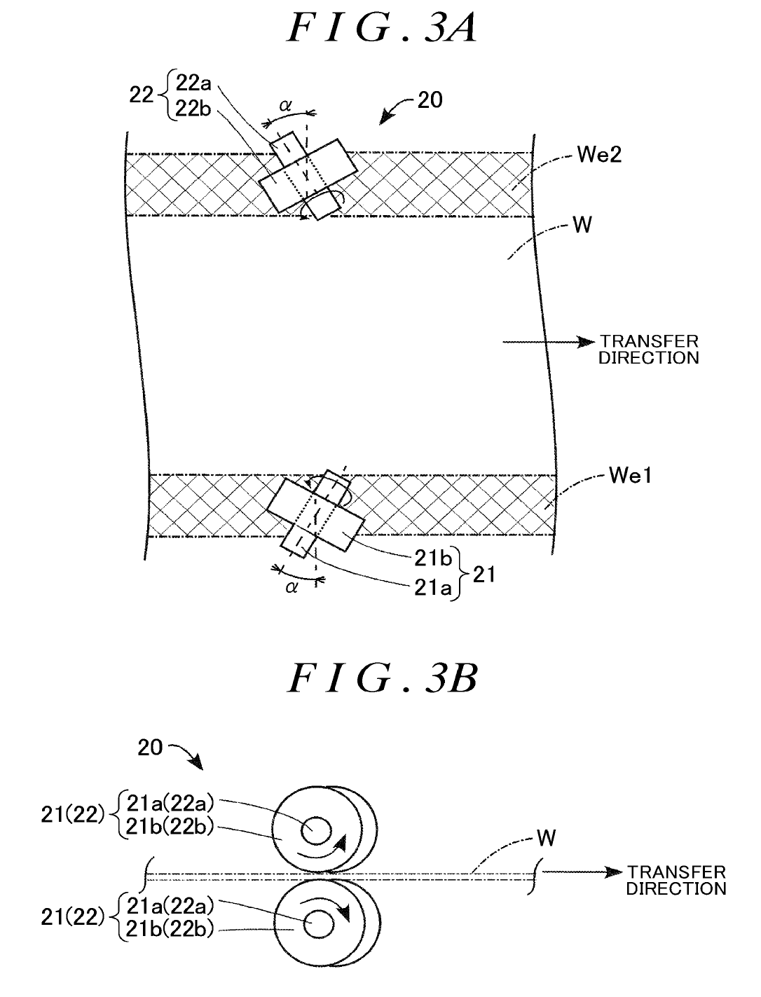

As shown in FIGS. 1, 3A, and 3B, the extending apparatus 20 includes a pair of first holding rollers 21, 21 and a pair of second holding rollers 22, 22. The pair of first holding rollers 21, 21 are placed so that they can rotate about their roller shafts 21a, 21a as the web W is transferred. The pair of second holding rollers 22, 22 are placed so that they can rotate about their roller shafts 22a, 22a as the web W is transferred. The pair of first holding rollers 21, 21 and the pair of second holding rollers 22, 22 can hold the web W therebetween at positions separated from the middle of the web W in the lateral direction of the web W when the web W is transferred.

The pair of first holding rollers 21, 21 are disposed such that their roller shafts 21a, 21a are parallel to each other and their outer peripheral surfaces 21b, 21b contact each other (such that the pair of first holding rollers 21, 21 contact the web W and hold the web W therebetween as the web W is transferred). The pair of second holding rollers 22, 22 have a configuration similar to that of the pair of first holding rollers 21, 21. The planar state of the web W that is transferred can therefore be accurately maintained.

The first holding rollers 21, 21 and the second holding rollers 22, 22 are disposed such that the distance in the lateral direction of the web W between the rotation axes of the roller shafts 21a, 21a of the first holding rollers 21, 21 and the rotation axes of the roller shafts 22a, 22a of the second holding rollers 22, 22 is smaller on the downstream side in the direction in which the web W is transferred than on the upstream side in the direction in which the web W is transferred (such that, when the contact surface (line) between the web W and the outer peripheral surfaces 21b, 21b of the first holding rollers 21, 21 moves as the web W is transferred and the contact surface (line) between the web W and outer peripheral surfaces 22b, 22b of the second holding rollers 22, 22 moves as the web W is transferred, the vectors of the contact surfaces (lines) extend outward to both sides of the web W) as viewed in the direction perpendicular to the surface of the web W (see FIG. 3A).

Since the first holding rollers 21, 21 hold both surfaces of a right end We1 in the lateral direction of the web W as viewed from the upstream side in the direction in which the web W is transferred, the roller shafts 21a, 21a are placed with their rotation axes rotated clockwise by a predetermined acute angle α with respect to the lateral direction of the web W. Since the second holding rollers 22, 22 hold both surfaces of a left end We2 in the lateral direction of the web W as viewed from the upstream side in the direction in which the web W is transferred, the roller shafts 22a, 22a are placed with their rotation axes rotated counterclockwise by the predetermined acute angle α with respect to the lateral direction of the web W.

The web W is thus subjected to tensile forces applied outward to both sides of the web W by the first holding rollers 21, 21 and the second holding rollers 22, 22 (due to contact pressures of the outer peripheral surfaces 21b, 21b and the outer peripheral surfaces 22b, 22b). Namely, the web W is subjected to components of frictional forces of the first holding rollers 21, 21 and the second holding rollers 22, 22 against the web W. When the web W passes through the first holding rollers 21, 21 and the second holding rollers 22, 22, the first holding rollers 21, 21 and the second holding rollers 22, 22 gradually extend the web W in the lateral direction of the web W.

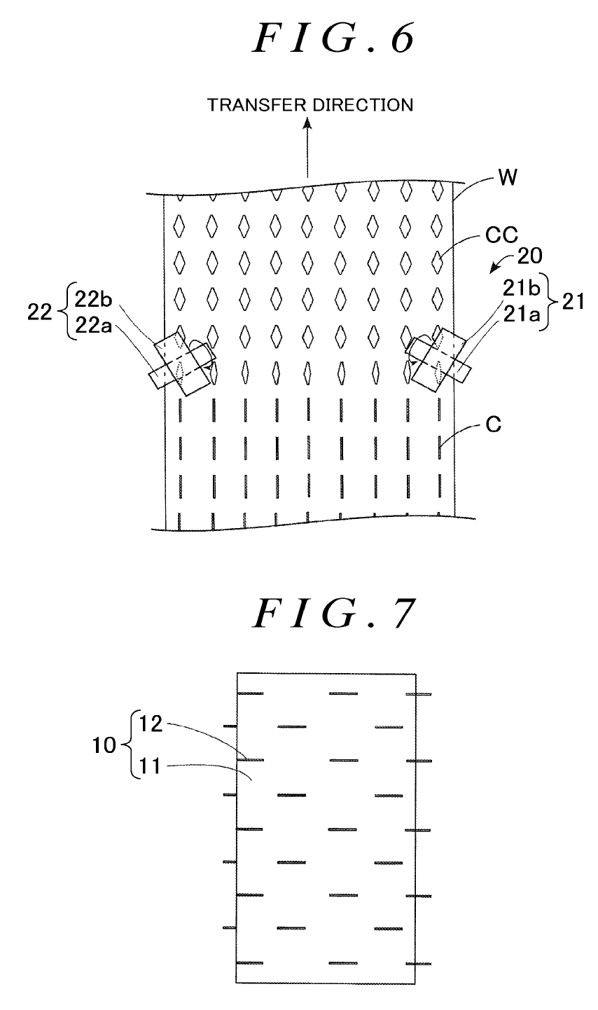

When the web W passes through the first holding rollers 21, 21 and the second holding rollers 22, 22, the first holding rollers 21, 21 and the second holding rollers 22, 22 widen the cuts C in the lateral direction of the web W to form holes CC (see FIG. 6). The cuts C can be easily widened in the lateral direction of the web W because the cuts C are made linearly in the direction in which the web W is transferred (the cuts C are made such that their length fin the direction in which the web W is transferred is larger than their length d in the lateral direction of the web W).

The contact pressures of the first holding rollers 21, 21 and the second holding rollers 22, 22 with the web W is related to the extension of the web W in the lateral direction of the web W. Accordingly, the degree to which the cuts C are widened in the lateral direction of the web W can be adjusted and the opening ratio of the web W (the area ratio of the holes CC per unit area of the web W) can be varied by changing these contact pressures (by adjusting the amount by which the first holding rollers 21, 21 and the second holding rollers 22, 22 slip on the web W and the amount by which the first holding rollers 21, 21 and the second holding rollers 22, 22 stretch the web W (the amount by which the first holding rollers 21, 21 and the second holding rollers 22, 22 stretch the web W in the lateral direction of the web W increases as the amount by which the first holding rollers 21, 21 and the second holding rollers 22, 22 slip on the web W decreases).

As shown in FIG. 1, the first and second coating material discharging apparatuses 30, 40 include die coaters 31, 41, pumps 32, 42, etc., respectively. The die coaters 31, 41 discharge the coating material S, and the pumps 32, 42 are connected to the die coaters 31, 41, respectively. The die coaters 31, 41 are known apparatuses and have slot orifices (dies) 31a, 41a, discharge ports 31b, 41b, etc., respectively. The discharge ports 31b, 41b have a width smaller than that of the web W. The die coaters 31, 41 are disposed such that the discharge ports 31b, 41b are separated by a predetermined gap length from surfaces Wa, Wb of the web W that is transferred, respectively.

The pumps 32, 42 are non-pulsatile pumps such as screw pumps and can supply the coating material S at a constant pressure and a constant flow rate. The coating material S is supplied from a coating material reservoir portion, not shown, to the slot orifices 31a, 41a of the die coaters 31, 41 by the pumps 32, 42. The coating material S thus supplied to the slot orifices 31a, 41a of the die coaters 31, 41 is pressurized and discharged from the discharge ports 31b, 41b to the surfaces Wa, Wb of the web W.

The first coating material discharging apparatus 30 and the second coating material discharging apparatus 40 are disposed on both sides of the web W so as to face each other with the web W interposed therebetween. The first coating material discharging apparatus 30 discharges the coating material S to one surface Wa of the web W having the cuts C (holes CC) widened in the lateral direction of the web W by the extending apparatus 20. The second coating material discharging apparatus 40 discharges the coating material S to the other surface Wb of the web W having the cuts C (holes CC) widened in the lateral direction of the web W by the extending apparatus 20. Providing the first coating material discharging apparatus 30 and the second coating material discharging apparatus 40 can reduce coating time because the coating material S can be applied to both surfaces Wa, Wb of the web W while the web W is being transferred.

The drying apparatus 50 includes a drying chamber 51 in the form of a hollow box, a plurality of hot air generators 52, etc. The drying chamber 51 has slits 51a, 51a in the middle of its opposing side surfaces so that the web W can be transferred through the slits 51a, 51a. Each of the hot air generators 52 contains a fan and a heater (both not shown) and has a nozzle port 52a from which generated hot air is blown. The plurality of hot air generators 52 are arranged on the upper surface and the bottom surface in the drying chamber 51 so that they can blow hot air from above and below onto the web W being transferred, and can simultaneously dry the coating material S applied to both surfaces Wa, Wb of the web W.

This configuration can reduce the drying time and the size of the drying apparatus 50 as compared to the case where the coating material S is dried one surface at a time. Moreover, since hot air is blown onto the web W, the web W floats in the air. The web W can thus be transferred in a non-contact manner. This can prevent damage to the coating material S applied to both surfaces Wa, Wb of the web W.

The transfer roller 60 is disposed between the drying apparatus 50 and the winding apparatus 80. The transfer roller 60 is rotatably supported on a body, not shown, of the web coating apparatus 1 by a bearing. The transfer roller 60 is disposed next to the drying apparatus 50 and the winding apparatus 80 such that its roller shaft 60a is parallel to the roller shafts 21a, 21a of the first holding rollers 21, 21 and the roller shafts 22a, 22a of the second holding rollers 22, 22 and such that the transfer roller 60 can horizontally support the web W held between the first holding rollers 21, 21 and between the second holding rollers 22, 22.

That is, the web W extends linearly between the first holding rollers 21, 21 and the second holding rollers 22, 22 and the transfer roller 60. This configuration restrains the web W from flapping when the web W is transferred, and allows the web W to be smoothly transferred. This can restrain variation in gap length between the discharge port 31b of the first coating material discharging apparatus 30 and the surface Wa of the web W and between the discharge port 41b of the second coating material discharging apparatus 40 and the surface Wb of the web W. Accordingly, the coating material S can be applied with a uniform thickness to the web W, and uniform quality of the coating material S can be ensured on the entire surfaces of the web W.

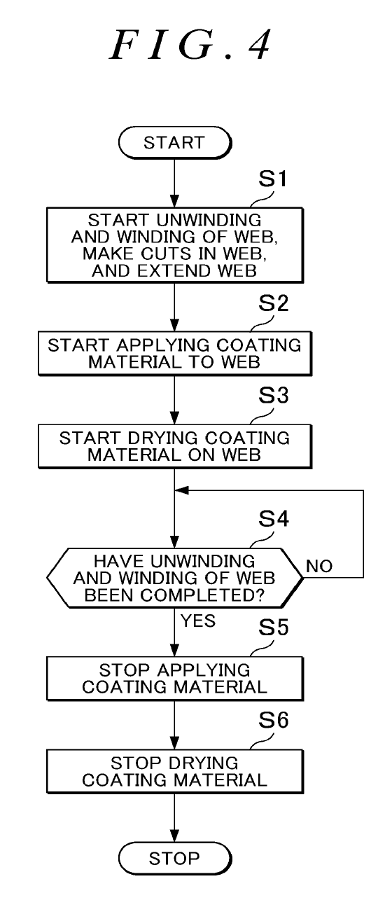

Operation of the web coating apparatus 1 will be described with reference to the flowchart of FIG. 4. It is herein assumed that the web W wound up into a roll has been set in the unwinding apparatus 70, and the tip end of the web W has been unwound from the unwinding apparatus 70 and wound up on the winding apparatus 80 via the cutting apparatus 10, the extending apparatus 20, the first and second coating material discharging apparatuses 30, 40, the drying apparatus 50, and the transfer roller 60 of the web coating apparatus 1.

The web coating apparatus 1 starts unwinding and winding of the web W, and makes the cuts C in the web W with the cutting edges 12 as shown in FIG. 5 while transferring the web W with one surface Wa of the web W in contact with the peripheral surface of the cutting roller 11. As shown in FIG. 6, the first holding rollers 21, 21 and the second holding rollers 22, 22 extend the web W in the lateral direction of the web W and widen the cuts C in the lateral direction of the web W to form the holes CC (step S1 in FIG. 4). The cuts C can be easily widened in the lateral direction of the web W because the cuts C are made linearly in the direction in which the web W is transferred.

The web coating apparatus 1 then operates the pumps 32, 42 of the first and second coating material discharging apparatuses 30, 40 so that the coating material S supplied from the coating material reservoir portion is discharged from the discharge ports 31b, 41b of the die coaters 31, 41 to both surfaces Wa, Wb of the web W (step S2 in FIG. 4). At this time, the coating material S is discharged at a fixed flow rate from the die coaters 31, 41, and the web W is transferred at a fixed rate. The coating material S discharged on both surfaces Wa, Wb of the web W is drawn by the web W and is thus applied with a uniform thickness to the web W. Since the coating material S is applied to the web W immediately after the holes CC are formed, the holes CC are filled with the coating material S, and reduction in strength of the web W can be prevented.

Subsequently, the web coating apparatus 1 operates the hot air generators 52 of the drying apparatus 50 to simultaneously dry the coating material S applied to both surfaces Wa, Wb of the web W (step S3 in FIG. 4). The coating material S applied to both surfaces Wa, Wb of the web W is thus dried more quickly than in the case where the coating material S is dried one surface at a time. The web coating apparatus 1 determines if the unwinding and winding of the web W have been completed (step S4 in FIG. 4). If the unwinding and winding of the web W has been completed, the web coating apparatus 1 stops the pumps 32, 42 of the first and second coating material discharging apparatuses 30, 40 (step S5 in FIG. 4) and stops the hot air generators 52 of the drying apparatus 50 (step S6 in FIG. 4). The entire process is thus completed.

For example, this web coating apparatus 1 is incorporated in a system that produces electrodes of batteries. In this case, the web W is metal foil, the coating material S is an electrode material in the form of slurry, and the web coating apparatus 1 applies the electrode material in the form of slurry to the metal foil while transferring the metal foil. For example, aluminum foil etc. is used as metal foil for positive electrodes of lithium ion capacitors, and copper foil etc. is used as metal foil for negative electrodes of the lithium ion capacitors. For example, activated carbon etc. is used as an electrode material for the positive electrodes of the lithium ion capacitors, and graphite etc. is used as an electrode material for the negative electrodes of the lithium ion capacitors.

The web coating apparatus 1 can produce electrodes having a reduced weight since metal foil is extended and holes CC are formed in the metal foil. Moreover, the web coating apparatus 1 can improve volumetric energy density (the volume of an active material to the overall volume of a battery) since the holes CC are filled with the electrode material.

In the above embodiment, the web coating apparatus 1 makes the cuts C such that the cuts C are arranged in a grid pattern. As shown in FIG. 7, however, the web coating apparatus 1 may make cuts C such that the cuts C are arranged in a staggered pattern. This can reduce a tensile force that is applied to the cuts C when the cuts C are widened by the extending apparatus 20 as compared to the case where the cuts C are arranged in the grid pattern, and can prevent the web W from being torn when the opening ratio of the web W is increased.

The web coating apparatus 1 makes the cuts C with the cutting edges 12 of the cutting roller 11. However, the web coating apparatus 1 may make the cuts C with beams of laser light etc. This eliminates the need for work, cost, etc. for replacement of the cutting roller 11 due to wear of the cutting edges 12 and can thus achieve reduction in manufacturing cost.

In the web coating apparatus 1, the degree to which the cuts C are widened in the lateral direction of the web W is adjusted and the opening ratio of the web W (the area ratio of the holes CC per unit area of the web W) is varied by changing the contact pressures of the first holding rollers 21, 21 and the second holding rollers 22, 22 with the web W. However, the opening ratio of the web W (the area ratio of the holes CC per unit area of the web W) may be varied by adjusting the angle of the first holding rollers 21, 21 and the second holding rollers 22, 22 with respect to the web W.

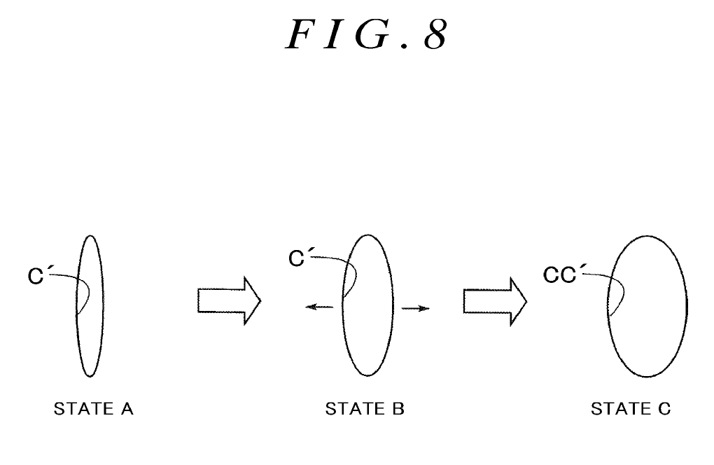

The web coating apparatus 1 makes the linear cuts C in the web W. As shown in state A of FIG. 8, however, the web coating apparatus 1 may make elliptical cuts C′ such that the major axes of the cuts C′ extend in the direction in which the web W is transferred. This cut C′ is gradually widened as shown in state B of FIG. 8 by the extending apparatus 20 to eventually form an elongated circular hole CC′ as shown in state C of FIG. 8.

The web coating apparatus 1 is an apparatus that applies the coating material S to both surfaces Wa, Wb of the web W. However, the web coating apparatus 1 may be an apparatus that applies the coating material S to only one surface Wa or Wb of the web W.

The web coating apparatus 1 is an apparatus that is incorporated in the system that produces electrodes of lithium ion capacitors. However, the web coating apparatus 1 may be an apparatus that is incorporated in a system that produces electrodes of lithium ion secondary batteries etc.

The web coating apparatus 1 of the present embodiment applies the coating material S to the surfaces Wa, Wb of the web W being transferred. The web coating apparatus 1 includes: the cutting apparatus 10 that makes the cuts C in the web W being transferred so that the cuts C extend through the web W; the extending apparatus 20 that extends the web W in the lateral direction of the web W and widens the cuts C in the lateral direction of the web W; and the coating material discharging apparatuses 30, 40 that applies the coating material S to the surfaces Wa, Wb of the web W extended in the lateral direction of the web W.

According to this configuration, the coating material S is applied after the cuts C are widened to form the holes CC. Accordingly, the coating material S can be made to remain in the holes CC. Since the holes CC are filled with the coating material S, reduction in strength of the web W can be prevented. Since the web W is extended in the lateral direction and the cuts C are thus widened to form the holes CC, the area ratio of the holes CC per unit area of the web W, namely the opening ratio of the web W, can be varied. Since the cuts C are widened to form the holes CC before the coating material S is applied, members located upstream of the coating material discharging apparatuses 30, 40 are not contaminated by the coating material S.

The cutting apparatus 10 makes the cuts C so that the length f of the cuts C in the direction in which the web W is transferred is larger than the length d of the cuts C in the lateral direction of the web W. Accordingly, the cuts C can be easily widened in the lateral direction of the web W.

The cutting apparatus 10 includes the cutting roller 11 that has the cutting edges 12 projecting from its peripheral surface and that makes the cuts C in the web W with the cutting edges 12 while transferring the web W with one surface Wa of the web W in contact with the peripheral surface of the cutting roller 11. Accordingly, transfer of the web W and making of the cuts C can be carried out at the same time, which simplifies the apparatus.

The extending apparatus 20 includes the pair of first holding rollers 21, 21 and the pair of second holding rollers 22, 22 which are disposed so that the web W can be held between the first holding rollers 21, 21 and the second holding rollers 22, 22 at positions separated from the middle of the web W in the lateral direction of the web W when the web W is transferred, and that the first holding rollers 21, 21 and the second holding rollers 22, 22 can rotate as the web W is transferred. The planar state of the web W that is transferred can therefore be accurately maintained.

The pair of first holding rollers 21, 21 and the pair of second holding rollers 22, 22 are disposed such that both ends We1, We2 in the lateral direction of the web W can be held between the first holding rollers 21, 21 and the second holding rollers 22, 22, and that the distance in the lateral direction of the web W between the rotation axes of the roller shafts 21a, 21a of the first holding rollers 21, 21 and the rotation axes of the roller shafts 22a, 22a of the second holding rollers 22, 22 is smaller on the downstream side in the direction in which the web W is transferred than on the upstream side in the direction in which the web W is transferred, as viewed in the direction perpendicular to the surface of the web W.

The web W is thus subjected to tensile forces applied outward to both sides of the web W by the first holding rollers 21, 21 and the second holding rollers 22, 22. Accordingly, the web W can be extended in the lateral direction of the web W and the cuts C can thus be widened in the lateral direction of the web W to form the holes CC. The web W can be extended in the lateral direction of the web W by the contact pressures of the first and second holding rollers 21, 21, 22, 22 with the web W. Accordingly, the degree to which the cuts C are widened in the lateral direction of the web W can be adjusted and the opening ratio of the web W (the area ratio of the holes CC per unit area of the web W) can be varied by changing the contact pressures.

Since the coating material discharging apparatuses 30, 40 apply the coating material S to both surfaces Wa, Wb of the web W, efficient coating can be achieved.

The web coating method of the present embodiment is a method for applying the coating material S to the surfaces Wa, Wb of the web W being transferred, including: making cuts C in the web W being transferred so that the cuts C extend through the web W; extending the web W in the lateral direction of the web W and widening the cuts C in the lateral direction of the web W; and applying the coating material S to the surfaces Wa, Wb of the web W extended in the lateral direction of the web W. The web coating method of the present embodiment has effects similar to those of the web coating apparatus 1 described above.

What is claimed is:

1. A web coating apparatus that applies a coating material to a surface of a web being transferred, the apparatus comprising:
a cutting apparatus that makes cuts in the web being transferred so that the cuts extend through the web;
an extending apparatus that extends the web in a lateral direction of the web and widens the cuts in the lateral direction of the web; and
a coating material discharging apparatus that applies the coating material to the surface of the web extended in the lateral direction of the web.

2. The web coating apparatus according to claim 1, wherein
the cutting apparatus makes the cuts so that a length of the cuts in a direction in which the web is transferred is larger than a length of the cuts in the lateral direction of the web.

3. The web coating apparatus according to claim 1, wherein
the cutting apparatus includes a cutting roller that has a cutting edge projecting from its peripheral surface and that makes the cuts in the web with the cutting edge while transferring the web with one surface of the web in contact with the peripheral surface of the cutting roller.

4. The web coating apparatus according to claim 1, wherein
the extending apparatus includes a pair of first holding rollers and a pair of second holding rollers which are disposed such that the web is held between the first holding rollers and the second holding rollers at positions separated from a middle of the web in the lateral direction of the web when the web is transferred, and that the first holding rollers and the second holding rollers can rotate as the web is transferred.

5. The web coating apparatus according to claim 4, wherein
the pair of first holding rollers and the pair of second holding rollers are disposed such that both ends in the lateral direction of the web is held between the first holding rollers and the second holding rollers, and that a distance in the lateral direction of the web between rotation axes of the first holding rollers and rotation axes of the second holding rollers is smaller on a downstream side in the direction in which the web is transferred than on an upstream side in the direction in which the web is transferred, as viewed in a direction perpendicular to the surface of the web.

6. The web coating apparatus according to claim 1, wherein
the coating material discharging apparatus applies the coating material to both surfaces of the web.

7. A web coating method for applying a coating material to a surface of a web being transferred, the method comprising:
making cuts in the web being transferred so that the cuts extend through the web;
extending the web in a lateral direction of the web and widening the cuts in the lateral direction of the web; and
applying the coating material to the surface of the web extended in the lateral direction of the web.
